(19) United States
(12) Patent Application Publication
(10) Pub. No.: US 2011/0010755 A1
(43) Pub. Date: Jan. 13, 2011

(54) INTERACTION BETWEEN SECURED AND UNSECURED ENVIRONMENTS

(76) Inventor: Jukka Tapio Virtanen, Helsinki (FI)

Correspondence Address: Locke Lord Bissell & Liddell LLP;Attn: IP Docketing, Three World Financial Center, New York, NY, 10281-2101, US

(21) Appl. No.: 12/747,766

(22) PCT Filed: Dec. 13, 2007
(86) PCT No.: PCT/EP07/10939

§ 371 Date: Sep. 22, 2010

(51) Int. Cl. G06F 21/00

(52) U.S. Cl. 726/2

(57) ABSTRACT

A method comprising: receiving a data structure including an identifier identifying a process for performance by a secured environment; and identifying to an unsecured environment the process identified by the data structure.

A method comprising: receiving at a secured environment a data structure including an identifier identifying a process for performance by the secured environment; and controlling at the secured environment performance of the identified process in dependence upon a signal received from an unsecured environment.

### FIELD OF THE INVENTION

Embodiments of the present invention relate to interaction between secured and unsecured environments.

### BACKGROUND TO THE INVENTION

It is now common for an apparatus to have a secured environment.

The International Standard ISO/IEC 7816, for example, defines a standard for IC cards, sometimes referred to as ‘smartcards. This standard has been adopted elsewhere such as by ETSI for specification of the SIM card and by Sun Microsystems in specifying the JavaCard. Secured environments are also specified in relation to digital rights management (DRM) standards such as Open Mobile Alliance (OMA) DRM.

Secured processes occur at a secured environment in such a way that unauthorised simulation of the process by another environment is frustrated. Typically, it is not advertised outside the secured environment what process is occurring while it is occurring. A secured algorithm used in the secured process is secured by its storage within the secured environment and a secured result of a secured process is secured either by its storage within the secured environment or by encryption if sent outside the secured environment.

The secured nature of the secured environment frustrates an unsecured environment outside the secured environment interacting with an on-going secured process.

### BRIEF DESCRIPTION OF VARIOUS EMBODIMENTS OF THE INVENTION

According to various embodiments of the invention there is provided a method comprising: receiving a data structure including an identifier identifying a process for performance by a secured environment; and identifying to an unsecured environment the process identified by the data structure.

Advantageously unsecured processing can be initiated when secured processing is initiated, this provides extra functionality.

According to various embodiments of the invention there is provided an apparatus comprising: an input interface configured to receive a data structure including an identifier identifying a process for performance by a secured environment; and an output interface configured to identify to an unsecured environment the process identified by the data structure.

According to various embodiments of the invention there is provided a computer program comprising instructions which when loaded into a processor enable the processor to: identify a received data structure as a particular type of data structure that includes an identifier identifying a particular one of many applications for performance by a secured environment and then extracting the identifier from the received data structure; and identifying to an unsecured environment the particular application identified by the extracted identifier.

According to various embodiments of the invention there is provided a module comprising: means for identifying a received data structure as a particular type of data structure that includes an identifier identifying a particular one of many applications for performance by a secured environment and then extracting the identifier from the received data structure; and means for identifying to an unsecured environment the particular application identified by the extracted identifier.

According to various embodiments of the invention there is provided an apparatus comprising: means for receiving a data structure including an identifier identifying a process for performance by a secured environment; and means for identifying to an unsecured environment the process identified by the data structure.

According to various embodiments of the invention there is provided a method comprising: receiving at a secured environment a data structure including an identifier identifying a process for performance by the secured environment; and controlling at the secured environment performance of the identified process in dependence upon a signal received from an unsecured environment.

Advantageously, secured processing can be dependent upon unsecured processes. This may enable a user to control the secured process. For example, the user may be able to prevent the secured process from completing.

According to various embodiments of the invention there is provided an apparatus comprising: a secured environment configured to receive a data structure including an identifier identifying a process for performance by the secured environment and configured to perform the identified process in dependence upon a signal received from an unsecured environment.

According to various embodiments of the invention there is provided an apparatus comprising: means for receiving at a secured environment a data structure including an identifier identifying a process for performance by the secured environment; and means for controlling at the secured environment performance of the identified process in dependence upon a signal received from an unsecured environment.

According to various embodiments of the invention there is provided a computer program comprising instructions which when loaded into a processor of a secured environment enable the processor to: perform a process identified by an identifier within a received data structure; and control performance of the identified process in dependence upon a signal received from an unsecured environment.

According to various embodiments of the invention there is provided a module comprising: means for providing a secured environment; means for receiving within the secured environment a data structure including an identifier identifying a process for performance within the secured environment; and means for controlling within the secured environment performance of the identified process in dependence upon a signal received from an unsecured environment.

The apparatus described above may be for communications, for wireless communications, for near field communications etc.

### BRIEF DESCRIPTION OF THE DRAWINGS

For a better understanding of various embodiments of the present invention reference will now be made by way of example only to the accompanying drawings in which:

FIG. 1 schematically illustrates a secured environment;

FIG. 2 schematically illustrates an unsecured environment;

FIGS. 3A, 3B and 3C schematically illustrate interaction between the secured environment and the unsecured environment;

FIGS. 4A and 4B schematically illustrate different prompts for user input;

FIG. 5 schematically illustrates an application protocol data unit (APDU);

FIG. 6 illustrates a near field communications embodiment;

FIG. 7 illustrates a method of providing an identification to an unsecured environment; and

FIG. 8 illustrates a method in which the identification triggers the performance of a process or processes by the unsecured environment.

### DETAILED DESCRIPTION OF VARIOUS EMBODIMENTS OF THE INVENTION

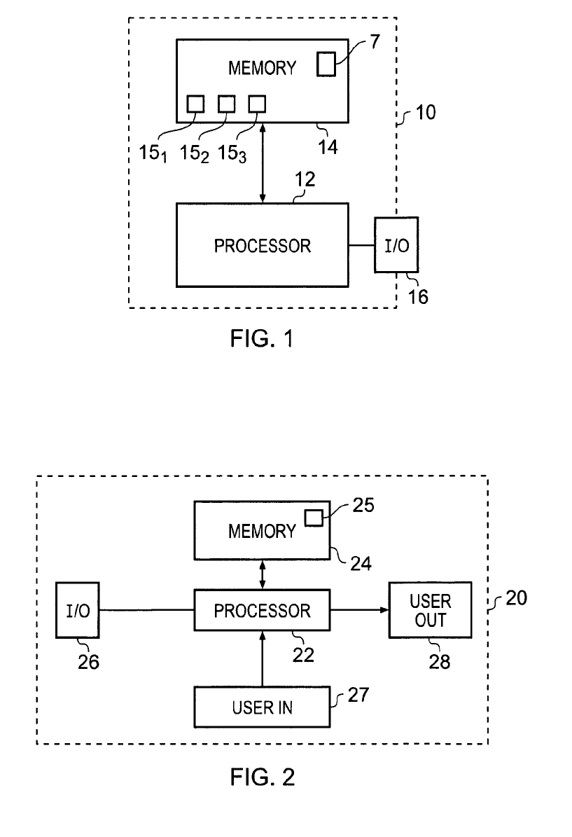

FIG. 1 schematically illustrates a secured environment 10. It is typically a computer or processing circuitry that uses security mechanisms such as authentication and encryption.

In FIG. 1, the secured environment comprises a processor 12, a memory system 14 and input/output interface(s) 16. The memory system 14 may, in some implementations, include a mixture of read-only memory (ROM), programmable memory (e.g. EEPROM) and dynamic memory (e.g. RAM). The memory system cannot be externally accessed and may be tamper resistant. It may store security data such as security algorithms for encryption and/or authentication and security data such as security keys, secrets or private data.

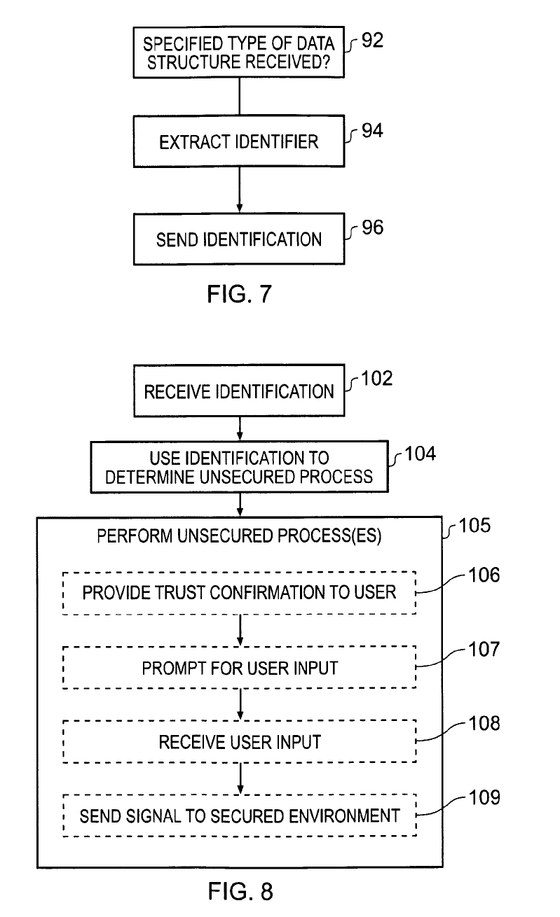

In the illustrated example, the memory system 14 stores in a tangibly encoded form a computer program 7 which enables the processor 12 to perform the method illustrated in FIG. 7 and stores a plurality of different applications 15 for performing different application-specific secured processes. The applications may, for example, be JavaCard applets.

The computer program 7 may arrive at the secured environment 10 via an electromagnetic carrier signal or be copied from a physical entity such as a computer program product, a memory device or a record medium such as a CD-ROM or DVD.

An application 15 may be referenced by a received data structure 3 that comprises an identifier 17 of one of the many applications 15.

The input/output interface 16 may be an interface that performs both input and output functions such as an interface to a computer bus. The input/output interface 16 may comprise an input interface and, separately, an output interface. The separate input interface may be directly connected to another component from which data is received or connected to a shared computer bus. The separate output interface may be directly connected to another component to which data is sent or connected to a shared computer bus.

FIG. 2 schematically illustrates an unsecured environment. The environment illustrated is unsecured in the sense that it does not have the same security measures as the secured environment. For example, it is configured to output information to a user via a user output device 28. The unsecured environment may, however, have some security measures. For example, components within the unsecured environment may be ‘locked’. A ‘locked’ component is a component with a programmable but locked state machine so that the component can be programmed at manufacture and then locked for use. The locking prevents the use varying the component's state machine.

The unsecured environment 20 is typically a host computer system comprising a processor 22, a memory system 24, input/output interface(s) 26, a user input device 27 and one or more user out devices 28 such as, for example a display.

The processor 22 is connected to read from and write to the memory 24 in which a computer program 25 is stored (tangibly encoded). The computer program 25 enables the processor to perform the method illustrated in FIG. 8.

The computer program 25 may arrive at the unsecured environment 20 via an electromagnetic carrier signal or be copied from a physical entity such as a computer program product, a memory device or a record medium such as a CD-ROM or DVD.

The processor 22 is also connected to receive data from and provide data to an input/output interface 26, to receive commands from a user input device 27 and provided commands to a user output device 28, such as a display.

The input/output interface 26 may be an interface that performs both input and output functions such as an interface to a computer bus. The input/output interface 16 may comprise an input interface and, separately, an output interface. The separate input interface may be directly connected to another component from which data is received or connected to a shared computer bus. The separate output interface may be directly connected to another component to which data is sent or connected to a shared computer bus.

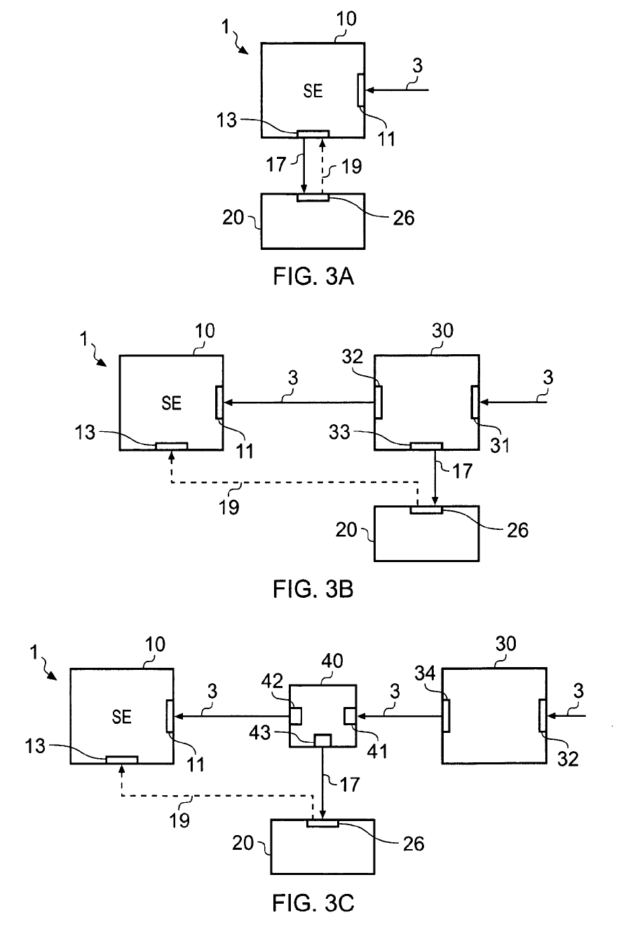

FIG. 3A schematically illustrates an apparatus 1 comprising: an input interface 11 configured to receive a data structure 3 including an identifier identifying a process 15 for performance by a secured environment 10; and an output interface 13 configured to identify to an unsecured environment 20 the process 15 identified by the data structure 3. The input interface 11 and the output interface 13 may be the I/O interfaces 16 of a secured environment 10, as previously described with reference to FIG. 1.

The unsecured environment 20 may be included within the apparatus 1 or the unsecured environment 20 may be included in a system that also includes the apparatus 1.

The processor 12 of the secured environment is configured by computer program instructions 7 stored in memory 14 to extract an identifier 17 from the data structure 3 as illustrated in the method of FIG. 7.

At block 92, the processor 12 detects when a data structure 3 received via the input interface 11 is a particular specified type of data structure. In this example, the processor 12 parses a header of the data structure 3 to determine when the header identifies the data structure 3 as a type that comprises in its payload an identifier 17 of one of many applications 15.

After positive detection, the method moves to block 94, where the processor 12 extracts the identifier 17 from the data structure 3. In this example, the processor 12 parses the data structure 3 to extract the identifier 17 from a data payload.

Then, at block 96, an identification (e.g. the identifier 17 or data based upon the identifier 17), is sent to the unsecured environment 20.

The processor 12 after extracting the identifier 17 at block 94, may automatically proceed to block 96 and send the identification to the unsecured environment 20. Alternatively, the processor 12 after extracting the identifier 17 at block 94, may automatically store the identifier and then proceed to block 96 after receiving a command from the host processor 22 in the unsecured environment 20. This enables flow control by the unsecured host environment 20 which may be engaged in other tasks from time to time. In one embodiment, the processor 22 sends a poll command to the secured environment 10 when it is ready to receive the identification. In another embodiment, at block 94 the processor 12 sends an interrupt to the processor 22 of the unsecured environment 20. In reply, when ready, the processor 22 sends a fetch command to the secured environment 10 when it is ready to receive the identification. When the secured environment 10 receives the fetch command, it proceeds to block 96 and sends the identification to the unsecured environment 20. After receiving the identification, the unsecured environment 20 sends an acknowledgement back to the secured environment 10.

The identification of the data structure and extraction of the identifier occurs in the secured environment 10, not in the unsecured host environment 20.

At the unsecured environment 20, the identification 17 may be used to trigger the performance of a process or processes by the unsecured environment 20. The triggered process may perform for a limited time period and may run in parallel to other functions of the unsecured host environment 20.

An example of a method for triggering the performance of processes is illustrated in FIG. 8.

At block 102, the unsecured environment 20, receives the identification 17 via the input/output interface 26. The identification 17 typically indicates which one of multiple applications 15 the secured environment 10 has been instructed to perform by the data structure 3.

Next, at block 104, the processor 22 of the unsecured environment 20 uses the received identification 17 to determine an unsecured process and then at block 105 performs the unsecured process.

Many different types of unsecured process may be performed. An ‘unsecured’ process is a process that is not wholly secure, that is a least a part of the process is carried out outside the secured environment 10. The Figure illustrates, an unsecured process in which the processor 22 provides a trust confirmation to a user or application at block 106 and provides a prompt for confirmatory user input at block 107, then receives the confirmatory user input at block 108 and finally sends a confirmation signal 19 to the secured environment 10.

The unsecured process illustrated in FIG. 8 enables the completion of the process initiated at the secured environment 10 by the data structure 3 to be prevented from terminating until the secured environment 10 receives the confirmation signal 19 from the unsecured environment 20. This enables a user to have confidence as to which one of the multiple applications 15 in the secured environment 10 is being used for a transaction and may also enable a user to prevent or suspend the transaction.

The memory 24 may store a database that associates different applications with application-specific data. When an identification 17 of a particular application is received, the database may be queried by processor 22 using the received identification 17. The database returns the application-specific data associated with that identification 17. The processor 22 then uses the application specific data to perform an application-specific process.

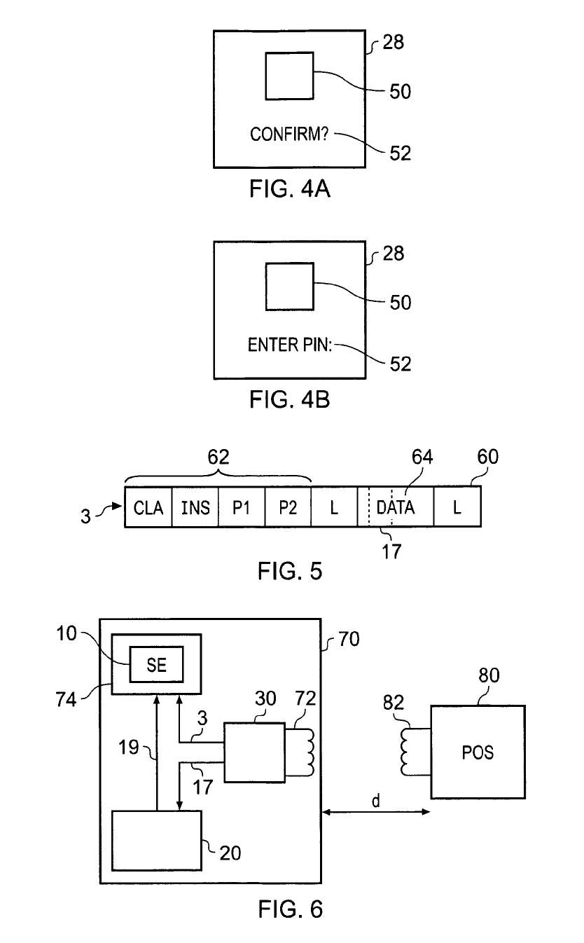

As an example, the multiple applications 15 in the secured environment 10 may include a plurality of financial instruments such as a MASTERCARD (Trademark) ‘credit card’ or a VISA (Trademark) ‘credit card’. The application-specific data stored in the database in this example could be an image of the logo for MASTERCARD (Trademark) and an image of the logo for VISA (Trademark). The application-specific process performed by the processor 22 may be the presentation in the display 28 of a particular logo 50 (FIG. 4A), when the identification 17 identifies that the data structure 3 instructed the initiation of a financial transaction using a financial instrument associated with that logo. The application-specific process performed by the processor 22 would, for example, be the presentation in the display 28 of the MASTERCARD (Trademark) logo 50, when the identification 17 identifies MASTERCARD (Trademark) and may be the presentation in the display 28 of the VISA (Trademark) logo 50, when the identification 17 identifies VISA (Trademark). The processor 22 may also present on the display 28 a prompt 52 that prompts the user to confirm his or her satisfaction with the financial transaction. In FIG. 4A, the confirmation merely requires a positive user input, whereas in FIG. 4B the confirmation requires that the user input a personal identification number (PIN) or other secret. After the user has confirmed his or her satisfaction with the financial transaction, a confirmation signal 19 may be sent to the secured environment 10 to enable completion of the financial transaction. The application-specific process in the unsecured host environment 20 is then terminated and the display 38 is used for other functions. The application-specific process may also be terminated if after a time-out period, no user confirmation is detected.

In the preceding paragraphs, the data structure 3 has been described without specificity as the format of the data structure 3 may change from implementation to implementation. At the current time, an International Standard ISO 7816-4, defines one type of data structure which are referred to in the specification as application protocol data units (APDU).

An APDU 60 is illustrated in FIG. 5. It has a command header 62 and a payload.

The command header 62 comprises a class byte CLA, an instruction byte INS and parameter bytes P1, P2. The payload has a Length field, a data field 64 and another length field.

A ‘select command’ is defined as an APDU 60 that has the instruction byte INS set to value A4. A select command that has the first parameter byte P1 set to value 04 indicates that an application identifier (AID) is used as a dedicated file (DF) name i.e. the application identifier (AID) 17 is within the data field 64.

The AID may, for example, have an ‘International’ category defined by value ‘A’ for bits 8 to 5 of the first byte of the data field 64. The following nine quartets may each have a value 0 to 9 defining a unique Internationally agreed identifier as described in ISO7815-5.

Continuing this example and referring to FIG. 7, at block 92 the specified type of data structure received is determined by parsing the command header 62 to identify the value for the instruction byte INS and the first parameter byte P1. When the instruction byte INS=A4 and the first parameter byte P1=04, then it is determined that the received APDU data structure 3 is a select command that uses a dedicated file name as an application identifier (AID). At block 94, the AID 17 is extracted from the data field 64 and at block 96 the AID 17 is sent to the unsecured environment 20.

A communication interface 30 such as a modem may be used to receive the data structure 3 from another entity and send it onto the secured environment 10. The method illustrated in FIG. 7, may be performed at the secured environment as previously described with reference to FIG. 3A or may be performed at the communication interface 30 as illustrated in FIG. 3B or may be performed by dedicated ‘sniffing’ circuitry 40 that is placed between the communication interface 30 and the secured environment 10 as illustrated in FIG. 3C.

In FIG. 3B, the apparatus 1 comprises the communication interface 30 and the secured environment 10 and may or may not include the unsecured environment 20. The communication interface 30 has an input interface 31 configured to receive the data structure 3 including an identifier identifying a process 15 for performance by a secured environment 10; and an output interface 33 configured to identify to an unsecured environment 20 the process 15 identified by the data structure 3. The communication interface 30 comprises circuitry such as a programmable processor or specific integrated circuitry that is configured to extract an identifier 17 from the data structure 3 and send it to the unsecured environment 20 as previously described with reference to FIG. 7. The identification of the data structure and extraction of the identifier occurs in the communication interface 30, not in the unsecured host environment 20.

After extracting the identifier 17 at block 94, the process may automatically proceed to block 96 and send the identification to the unsecured environment 20. Alternatively, after extracting the identifier 17 at block 94, the communications interface 30 may automatically store the identifier and then proceed to block 96 after receiving a command from the unsecured environment 20. This enables flow control by the unsecured host environment 20 which may be engaged in other tasks from time to time. In one embodiment, the unsecured environment 20 sends a poll command to the secured environment 10 when it is ready to receive the identification. In another embodiment, at block 94 the communications interface 20 sends an interrupt to the unsecured environment 20. In reply, when ready, the unsecured environment 20 sends a fetch command to the communications interface 30 when it is ready to receive the identification. When the secured environment 10 receives the fetch command, it proceeds to block 96 and sends the identification to the unsecured environment 20. After receiving the identification, the unsecured environment 20 sends an acknowledgement back to the secured environment 10.

Although the communication interface 30 and secured environment 10 are illustrated as separate functional components in FIG. 3B, the function of the secured environment may be performed by one or more physical components and the function of the communication interface 30 may be performed by one or more physical components. The secured environment 10 and the communication interface 30 may be physically integrated, for example on the same chip set or module, but remain functionally distinct or may be physically distinct.

The communications interface 30 may have its own computer and memory, where the memory stores computer program code for controlling the communications interface 30. The program code may, for example, be ‘locked’.

In FIG. 3C, the apparatus 1 comprises the communication interface 30, the unsecured environment 20, dedicated ‘sniffing’ circuitry 40 and may or may not include the unsecured environment 20. The dedicated sniffing circuitry 40 has an input interface 41 configured to receive the data structure 3 from the communications interface 30. The data structure 3 may include an identifier identifying a process 15 for performance by a secured environment 10. The dedicated sniffing circuitry 40 has an output interface 43 configured to identify to an unsecured environment 20 the process 15 identified by the data structure 3. The dedicating sniffing circuitry 40 comprises circuitry such as a programmable processor or specific integrated circuitry that is configured to extract an identifier 17 from the data structure 3 and send it to the unsecured environment 20 as previously described with reference to FIG. 7.

The identification of the data structure and extraction of the identifier occurs in the dedicated ‘sniffing’ circuitry 40, not in the unsecured host environment 20.

After extracting the identifier 17 at block 94, the process may automatically proceed to block 96 and send the identification to the unsecured environment 20. Alternatively, after extracting the identifier 17 at block 94, the dedicated sniffing circuitry 40 may automatically store the identifier and then proceed to block 96 after receiving a command from the unsecured environment 20. This enables flow control by the unsecured host environment 20 which may be engaged in other tasks from time to time. In one embodiment, the unsecured environment 20 sends a poll command to the secured environment 10 when it is ready to receive the identification. In another embodiment, at block 94 the communications interface 20 sends an interrupt to the unsecured environment 20. In reply, when ready, the unsecured environment 20 sends a fetch command to the dedicated sniffing circuitry 40 when it is ready to receive the identification. When the secured environment 10 receives the fetch command, it proceeds to block 96 and sends the identification to the unsecured environment 20. After receiving the identification, the unsecured environment 20 sends an acknowledgement back to the secured environment 10.

The dedicated sniffing circuitry 40 may have its own computer and memory, where the memory stores computer program code for controlling the dedicated sniffing circuitry 40. The program code may, for example, be ‘locked’.

As described above a communications interface 30 may provide the data structure 3 to the secured environment 10. The communications interface 30 may receive the data structure from another entity via galvanic contacts or wirelessly (contactlessly). One form of wireless communication is defined in the GSM standard in which the communication interface 30 is a mobile cellular telephone and the secured environment 10 is a SIM card. Another form of wireless communication is defined in the wireless interface module (WIM) standard where the communication interface 30 is a Bluetooth transceiver and the secured environment 10 is a WIM card.

The communications interface 30 may be a proximity wireless interface such as that specified by the near field communications (NFC) organisation or specified for radio frequency identification (RFID). As illustrated in FIG. 6, a point of sale (POS) device 80 has an inductive coupler 82 and a hand-portable apparatus 70 comprises a communications interface 30 that also has an inductive coupler 72. When the apparatus 70 and the POS device 80 are brought into close proximity (e.g. less than 10 or less than 5 cm) the inductive coupler 72 and 82 are able to couple together and enable communication across the small gap d. This inductive coupling is used to transfer the data structure 3 from the POS device 80 to the hand-portable apparatus 70. If the gap d is increased beyond 10 cm inductive communication is no longer possible across the gap.

The hand-portable apparatus 70 is similar to the apparatus 1 described with reference to FIG. 3B. It also comprises a secured environment 10 and an unsecured environment 20. The communications interface 30 sends the data structure 3 to the secured environment and the identification 17 to the unsecured environment 20. The unsecured environment 20 may be configured to send a confirmation signal 19 to the secured environment 10.

Referring back to FIGS. 4A to 4C, the apparatus 1 may be a device or a module for a device. A device may, for example, be hand-portable, A device may, for example, be a personal digital assistant, personal computer, personal music player, mobile cellular telephone, electronic wallet etc. If the apparatus is a module, it may form a system when connected to a device. As used here ‘module’ refers to a unit or apparatus that excludes certain parts/components that would be added by an end manufacturer or a user.

The blocks illustrated in the FIGS. 7 and 8 may represent steps in a method and/or sections of code in the computer programs 7, 25. The illustration of a particular order to the blocks does not necessarily imply that there is a required or preferred order for the blocks and the order and arrangement of the block may be varied.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. A method comprising:
receiving a data structure including an identifier identifying a process for performance by a secured environment; and
identifying to an unsecured environment the process identified by the data structure.

2. A method as claimed in claim 1, further comprising: providing the received data structure to the secured environment.

3. A method as claimed in claim 1, wherein identifying the process comprises: extracting an identifier from the received data structure.

4. A method as claimed in claim 56, wherein the identifier for a particular application has a standard unique form determined by multi-party agreement.

5. A method as claimed in claim 1, wherein identifying the process comprises: identifying the received data structure as a particular type of data structure.

6. A method as claimed in claim 5, wherein the particular type is a data structure comprising an identifier of one of many applications.

7. (canceled)

8. A method as claimed in claim 1, comprising performing an unsecured process at the unsecured environment based upon said identification.

9. (canceled)

10. A method as claimed in claim 8, wherein the unsecured process is selected from the group comprising: prompting a user confirmation; sending a signal to the secured environment; and presenting a visual indication on a display.

11. (canceled)

12. (canceled)

13. A method as claimed in claim 1, wherein the process for performance at the secured environment is dependent upon an input from the unsecured environment.

14. A method as claimed in claim 13, wherein completion of the process by the secured environment is prevented until the input from the unsecured environment is received.

15. A method as claimed in claim 1, wherein the data structure is an application protocol data unit (APDU) select command comprising an application identifier (AID).

16. A method as claimed in claim 1, wherein the secured environment and the unsecured environment are distinct computer systems.

17. (canceled)

18. An apparatus comprising:
an input interface configured to receive a data structure including an identifier identifying a process for performance by a secured environment; and
an output interface configured to identify to an unsecured environment the process identified by the data structure.

19. (canceled)

20. (canceled)

21. An apparatus as claimed in claim 18, wherein the circuitry is configured to extract an identifier from the received data structure.

22. An apparatus as claimed in claim 18, wherein the input interface and the output interface are interfaces of the secured environment, and wherein the process for performance at the secured environment is dependent upon an input from the unsecured environment.

23. (canceled)

24. An apparatus as claimed in claim 22, wherein the input is a user confirmation, and wherein completion of the process is prevented until the input is received.

25. (canceled)

26. (canceled)

27. (canceled)

28. (canceled)

29. An apparatus as claimed in claim 18, further comprising the unsecured environment, wherein the unsecured environment is configured to perform an unsecured process based upon said identification of the process for performance at the secured environment wherein the unsecured process provides a prompt for user confirmation.

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. A method comprising:
receiving at a secured environment a data structure including an identifier identifying a process for performance by the secured environment; and
controlling at the secured environment performance of the identified process in dependence upon a signal received from an unsecured environment.

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. A method as claimed in claim 3, wherein the identifier identifies one particular application of many applications.

57. A method as claimed in claim 1, wherein the process for performance is application specific and is performed using an application stored within the secured environment.
